(19) United States
(12) Patent Application Publication
(10) Pub. No.: US 2010/0260108 A1
(43) Pub. Date: Oct. 14, 2010

(54) SETTING UP A REVERSE LINK DATA TRANSMISSION WITHIN A WIRELESS COMMUNICATIONS SYSTEM

(75) Inventors: BONGYONG SONG, San Diego, CA (US); Yih-Hao Lin, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/755,841

(22) Filed: Apr. 7, 2010

Related U.S. Application Data
(60) Provisional application No. 61/168,857, filed on Apr. 13, 2009.

(51) Int. Cl. H04W 40/00

(52) U.S. Cl. 370/328

(57) ABSTRACT

Aspects including methods and apparatuses for setting up a reverse link data transmission within a wireless communications system are disclosed. An access terminal sends, to an access network, an initial data packet in a sequence of data packets including a data portion and a header portion including an identifier of a first type, the identifier of the first type configured to uniquely identify the given access terminal in more than one of a subset of sectors of the wireless communications system. The access network sends a message to the access terminal to (i) assign a dedicated channel to the given access terminal, or to (ii) assign an identifier of a second type to uniquely identify the given access terminal in a single sector of the wireless communications system. The access network thereafter receives additional packets from the access terminal in accordance with the assignment.

The present application for patent claims priority to Provisional Application No. 61/168,857, entitled “SETTING UP A REVERSE LINK DATA TRANSMISSION WITHIN A WIRELESS COMMUNICATIONS SYSTEM”, filed Apr. 13, 2009, assigned to the assignee hereof and hereby expressly incorporated by reference herein in its entirety.

### BACKGROUND OF THE INVENTION

1. Field of the Invention

Embodiments of the invention relates to setting up a reverse link data transmission within a wireless communications system.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (WCDMA), CDMA2000 (such as CDMA2000 1xEV-DO standards, for example) or TD-SCDMA.

In wireless communication systems, mobile stations, handsets, or access terminals (AT) receive signals from fixed position base stations (also referred to as cell sites or cells) that support communication links or service within particular geographic regions adjacent to or surrounding the base stations. Base stations provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the base stations generally interact with ATs through an over the air interface and with the AN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as CDMA, FDMA, TDMA, GSM, etc. In a dispatch model, communication between endpoints (ATs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

Conventionally, data packets within a wireless communication network have been configured to be sent to a single destination or access terminal. A transmission of data to a single destination is referred to as “unicast”. As mobile communications have increased, the ability to transmit given data concurrently to multiple access terminals has become more important. Accordingly, protocols have been adopted to support concurrent data transmissions of the same packet or message to multiple destinations or target access terminals. A “broadcast” refers to a transmission of data packets to all destinations or access terminals (e.g., within a given cell, served by a given service provider, etc.), while a “multicast” refers to a transmission of data packets to a given group of destinations or access terminals. In an example, the given group of destinations or “multicast group” may include more than one and less than all of possible destinations or access terminals (e.g., within a given group, served by a given service provider, etc.). However, it is at least possible in certain situations that the multicast group comprises only one access terminal, similar to a unicast, or alternatively that the multicast group comprises all access terminals (e.g., within a given cell, etc.), similar to a broadcast.

### SUMMARY

Aspects including methods and apparatuses for setting up a reverse link data transmission within a wireless communications system are disclosed. An access terminal sends, to an access network, an initial data packet in a sequence of data packets including a data portion and a header portion including an identifier of a first type, the identifier of the first type configured to uniquely identify the given access terminal in more than one of a subset of sectors of the wireless communications system. The access network sends a message to the access terminal to (i) assign a dedicated channel to the given access terminal, or to (ii) assign an identifier of a second type to uniquely identify the given access terminal in a single sector of the wireless communications system. The access network thereafter receives additional packets from the access terminal in accordance with the assignment.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2 illustrates the carrier network according to an embodiment of the present invention.

FIG. 3 is an illustration of an access terminal in accordance with at least one embodiment of the invention.

FIGS. 4A and 4B each illustrate a conventional process of setting up a reverse link data transmission.

FIG. 5 illustrates a conventional process of setting up a reverse link data transmission performed in accordance with 3GPP Release 8.

FIG. 6 illustrates a process of setting up a reverse link data transmission according to an embodiment of the present invention.

FIG. 7 illustrates a media access control (MAC) packet according to an embodiment of the present invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A Universal Mobile Telecommunication System (UMTS) mobile station, referred to herein as an access terminal (AT), may be mobile or stationary, and may communicate with one or more UMTS base stations, referred to herein as Node B. An access terminal transmits and receives data packets through one or more Node B's to an UMTS base station controller, referred to as a Radio Network Controller (RNC). Node B and RNC are parts of a network called an access network. An access network transports data packets between multiple access terminals.

The access network may be further connected to additional networks outside the access network, such as a corporate intranet or the Internet, and may transport data packets between each access terminal and such outside networks. An access terminal that has established an active traffic channel connection with one or more modem pool transceivers is called an active access terminal, and is said to be in a traffic state. An access terminal that is in the process of establishing an active traffic channel connection with one or more modem pool transceivers is said to be in a connection setup state. An access terminal may be any data device that communicates through a wireless channel or through a wired channel, for example using fiber optic or coaxial cables. An access terminal may further be any of a number of types of devices including but not limited to PC card, compact flash, external or internal modem, or wireless or wireline phone. The communication link through which the access terminal sends signals to the modem pool transceiver is called a reverse link or traffic channel. The communication link through which a modem pool transceiver sends signals to an access terminal is called a forward link or traffic channel. As used herein the term traffic channel can refer to either a forward or reverse traffic channel.

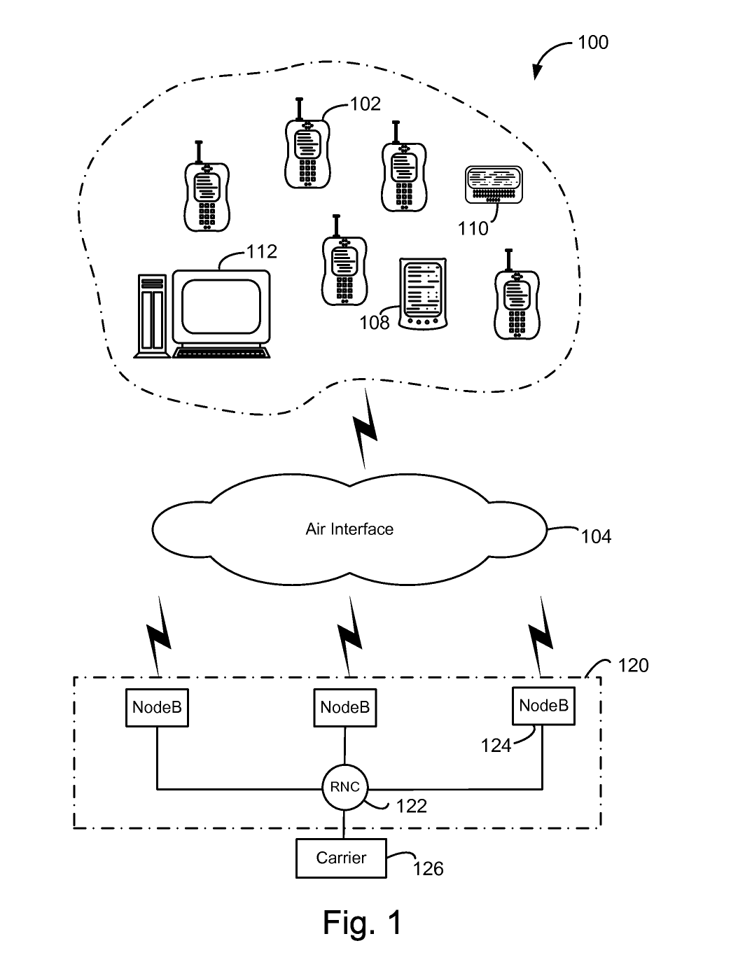

FIG. 1 illustrates a block diagram of one exemplary embodiment of a wireless system 100 in accordance with at least one embodiment of the invention. System 100 can contain access terminals, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or carrier network 126) and the access terminals 102, 108, 110, 112. As shown here, the access terminal can be a cellular telephone 102, a personal digital assistant 108, a pager 110, which is shown here as a two-way text pager, or even a separate computer platform 112 that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof. Further, as used herein, the terms “access terminal”, “wireless device”, “client device”, “mobile terminal” and variations thereof may be used interchangeably.

Referring back to FIG. 1, the components of the wireless network 100 and interrelation of the elements of the exemplary embodiments of the invention are not limited to the configuration illustrated. System 100 is merely exemplary and can include any system that allows remote access terminals, such as wireless client computing devices 102, 108, 110, 112 to communicate over-the-air between and among each other and/or between and among components connected via the air interface 104 and RAN 120, including, without limitation, carrier network 126, the Internet, and/or other remote servers.

The RAN 120 controls messages (typically sent as data packets) sent to a Radio Network Controller (RNC) 122. The RNC 122 is responsible for signaling, establishing, and tearing down bearer channels (i.e., data channels) between a Serving General Packet Radio Services (GPRS) Support Node (SGSN) 160 and the access terminals 102/108/110/112. If link layer encryption is enabled, the RNC 122 also encrypts the content before forwarding it over the air interface 104. The function of the RNC 122 is well-known in the art and will not be discussed further for the sake of brevity. The carrier network 126 may communicate with the RNC 122 by a network, the Internet and/or a public switched telephone network (PSTN). Alternatively, the RNC 122 may connect directly to the Internet or external network. Typically, the network or Internet connection between the carrier network 126 and the RNC 122 transfers data, and the PSTN transfers voice information. The RNC 122 can be connected to multiple base stations (Node B) 124. In a similar manner to the carrier network, the RNC 122 is typically connected to the Node B 124 by a network, the Internet and/or PSTN for data transfer and/or voice information. The Node B 124 can broadcast data messages wirelessly to the access terminals, such as cellular telephone 102. The Node B 124, RNC 122 and other components may form the RAN 120, as is known in the art. However, alternate configurations may also be used and the invention is not limited to the configuration illustrated. For example, in another embodiment the functionality of the RNC 122 and one or more of the Node B 124 may be collapsed into a single “hybrid” module having the functionality of both the RNC 122 and the Node B 124.

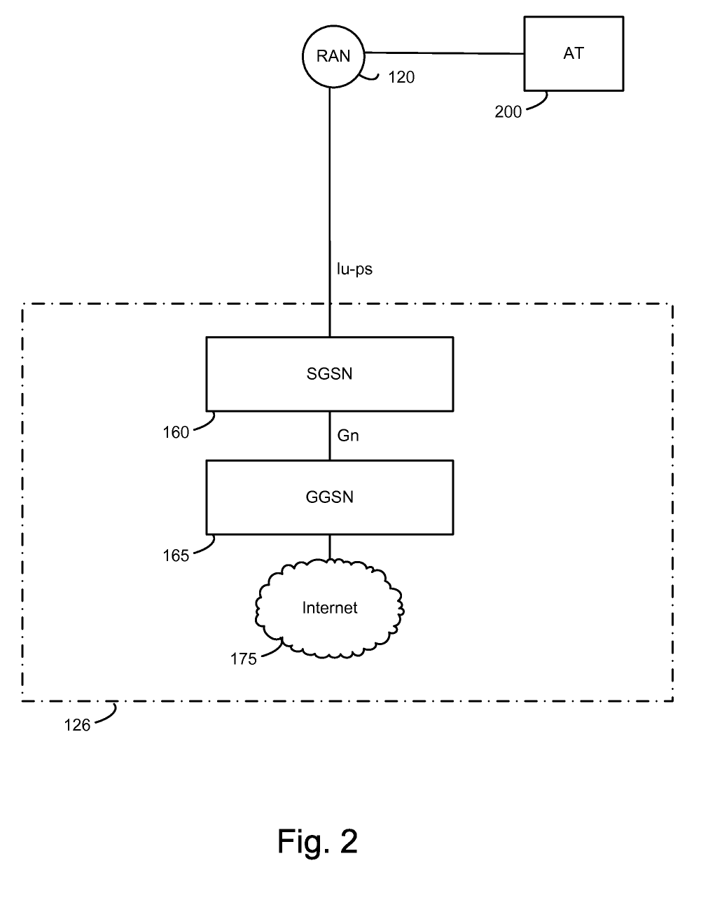

FIG. 2 illustrates the carrier network 126 according to an embodiment of the present invention. In particular, the carrier network 126 illustrates components of a General Packet Radio Services (GPRS) core network. In the embodiment of FIG. 2, the carrier network 126 includes a Serving GPRS Support Node (SGSN) 160, a Gateway GPRS Support Node (GGSN) 165 and an Internet 175. However, it is appreciated that portions of the Internet 175 and/or other components may be located outside the carrier network in alternative embodiments.

Generally, GPRS is a protocol used by Global System for Mobile communications (GSM) phones for transmitting Internet Protocol (IP) packets. The GPRS Core Network (e.g., the GGSN 165 and one or more SGSNs 160) is the centralized part of the GPRS system and also provides support for W-CDMA based 3G networks. The GPRS core network is an integrated part of the GSM core network, provides mobility management, session management and transport for IP packet services in GSM and W-CDMA networks.

The GPRS Tunneling Protocol (GTP) is the defining IP protocol of the GPRS core network. The GTP is the protocol which allows end users (e.g., access terminals) of a GSM or W-CDMA network to move from place to place while continuing to connect to the internet as if from one location at the GGSN 165. This is achieved transferring the subscriber's data from the subscriber's current SSGN 160 to the GGSN 165, which is handling the subscriber's session.

Three forms of GTP are used by the GPRS core network; namely, (i) GTP-U, (ii) GTP-C and (iii) GTP′ (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP′ is used for transfer of charging data from GSNs to a charging function.

Referring to FIG. 2, the GGSN 165 acts as an interface between the GPRS backbone network (not shown) and the external packet data network 175. The GGSN 165 extracts the packet data with associated packet data protocol (PDP) format (e.g., IP or PPP) from the GPRS packets coming from the SGSN 160, and sends the packets out on a corresponding packet data network. In the other direction, the incoming data packets are directed by the GGSN 165 to the SGSN 160 which manages and controls the Radio Access Bearer (RAB) of the destination AT served by the RAN 120. Thereby, the GGSN 165 stores the current SGSN address of the target AT and his/her profile in its location register (e.g., within a PDP context). The GGSN is responsible for IP address assignment and is the default router for the connected AT. The GGSN also performs authentication and charging functions.

The SGSN 160 is representative of one of many SGSNs within the carrier network 126, in an example. Each SGSN is responsible for the delivery of data packets from and to the mobile stations or ATs within an associated geographical service area. The tasks of the SGSN 160 include packet routing and transfer, mobility management (e.g., attach/detach and location management), logical link management, and authentication and charging functions. The location register of the SGSN stores location information (e.g., current cell, current VLR) and user profiles (e.g., IMSI, PDP address(es) used in the packet data network) of all GPRS users registered with the SGSN 160, for example, within one or more PDP contexts for each user or AT. Thus, SGSNs are responsible for (i) de-tunneling downlink GTP packets from the GGSN 165, (ii) uplink tunnel IP packets toward the GGSN 165, (iii) carrying out mobility management as ATs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in Universal Mobile Telecommunications System (UMTS) system architecture) communicates with the SGSN 160 via a Iu interface, with a transmission protocol such as Frame Relay or IP. The SGSN 160 communicates with the GGSN 165 via a Gn interface, which is an IP-based interface between SGSN 160 and other SGSNs (not shown) and internal GGSNs, and uses the GTP protocol defined above (e.g., GTP-U, GTP-C, GTP′, etc.). While not shown in FIG. 2, the Gn interface is also used by the Domain Name System (DNS). The GGSN 165 is connected to a Public Data Network (PDN) (not shown), and in turn to the Internet 175, via a Gi interface with IP protocols either directly or through a Wireless Application Protocol (WAP) gateway.

The PDP context is a data structure present on both the SGSN 160 and the GGSN 165 which contains a particular AT's communication session information when the AT has an active GPRS session. When an AT wishes to initiate a GPRS communication session, the AT must first attach to the SGSN 160 and then activate a PDP context with the GGSN 165. This allocates a PDP context data structure in the SGSN 160 that the subscriber is currently visiting and the GGSN 165 serving the AT's access point.

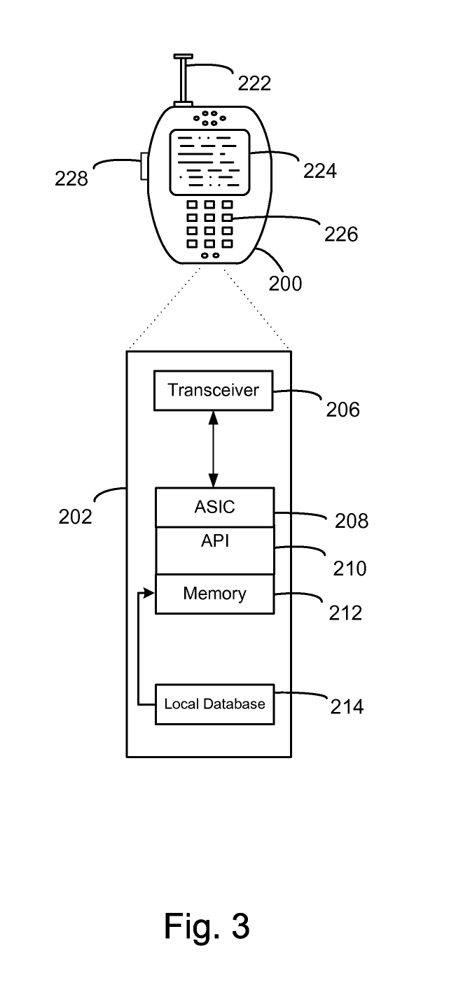

Referring to FIG. 3, an access terminal 200, (here a wireless device), such as a cellular telephone, has a platform 202 that can receive and execute software applications, data and/or commands transmitted from the RAN 120 that may ultimately come from the carrier network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include an access terminal including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the access terminal in FIG. 3 are to be considered merely illustrative and the invention is not limited to the illustrated features or arrangement.

The wireless communication between the access terminal 102 and the RAN 120 can be based on different technologies, such as code division multiple access (CDMA), WCDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. The data communication is typically between the client device 102, Node B 124, and RNC 122. The RNC 122 can be connected to multiple data networks such as the carrier network 126, PSTN, the Internet, a virtual private network, and the like, thus allowing the access terminal 102 access to a broader communication network. As discussed in the foregoing and known in the art, voice transmission and/or data can be transmitted to the access terminals from the RAN using a variety of networks and configurations. Accordingly, the illustrations provided herein are not intended to limit the embodiments of the invention and are merely to aid in the description of aspects of embodiments of the invention.

Access terminals, or User Equipments (UEs), in a Universal Mobile Telecommunications Service (UMTS) Terrestrial Radio Access Network (UTRAN) (e.g., the RAN 120) may be in either an idle mode or a connected mode. Below, reference is made to the RAN 120 and ATs, although it is appreciated that, when applied to UMTS, this terminology may be used to refer to the UTRAN and UEs, respectively.

Based on AT mobility and activity while in a radio resource control (RRC) connected mode, the RAN 120 may direct ATs to transition between a number of RRC sub-states; namely, CELL_PCH, URA_PCH, CELL_FACH, and CELL_DCH states, which may be characterized as follows:
In the CELL_DCH state, a dedicated physical channel is allocated to the AT in uplink and downlink, the AT is known on a cell level according to its current active set, and the AT has been assigned dedicated transport channels, downlink and uplink time division duplex (TDD) shared transport channels, and a combination of these transport channels can be used by the AT.
In the CELL_FACH state, no dedicated physical channel is allocated to the AT, the AT continuously monitors a forward access channel (FACH), the AT is assigned a default common or shared transport channel in the uplink (e.g., a random access channel (RACH), which is a contention-based channel with a power ramp-up procedure to acquire the channel and to adjust transmit power) that the AT can transmit upon according to the access procedure for that transport channel, the position of the AT is known by RAN 120 on a cell level according to the cell where the AT last made a previous cell update, and, in TDD mode, one or several USCH or DSCH transport channels may have been established.
In the CELL_PCH state, no dedicated physical channel is allocated to the AT, the AT selects a PCH with the algorithm, and uses DRX for monitoring the selected PCH via an associated PICH, no uplink activity is possible and the position of the AT is known by the RAN 120 on cell level according to the cell where the AT last made a cell update in CELL_FACH state.
In the URA_PCH state, no dedicated channel is allocated to the AT, the AT selects a PCH with the algorithm, and uses DRX for monitoring the selected PCH via an associated PICH, no uplink activity is possible, and the location of the AT is known to the RAN 120 at a Registration area level according to the UTRAN registration area (URA) assigned to the AT during the last URA update in CELL_FACH state.

Accordingly, URA_PCH State (or CELL_PCH State) corresponds to an dormant state where the AT periodically wakes up to check a downlink paging channel (PCH), and enters CELL_FACH state to send a Cell Update message. In CELL_FACH State, the AT may send messages on the RACH, and may monitor a FACH. The FACH carries downlink communication from the RAN 120, and is mapped to a secondary common control physical channel (S-CCPCH). From CELL_FACH State, the AT may enter CELL_DCH state after a traffic channel (TCH) has been obtained based on messaging in CELL_FACH state. A table showing conventional dedicated traffic channel (DTCH) to transport channel mappings in radio resource control (RRC) connected mode, is in Table 1 as follows:

TABLE 1
DTCH to Transport Channel mappings in RRC connected mode

| | RACH | FACH | DCH | E-DCH | HS-DSCH |
|---|---|---|---|---|---|
| CELL_DCH | Yes | Yes | Yes | Yes | Yes |
| CELL_FACH | Yes | Yes | No | Yes (rel. 8) | Yes (rel. 7) |
| CELL_PCH | No | No | No | No | Yes (rel. 7) |
| URA_PCH | No | No | No | No | No |

wherein the notations (rel. 8) and (rel. 7) indicate the associated 3GPP release where the indicated channel was introduced for monitoring or access.

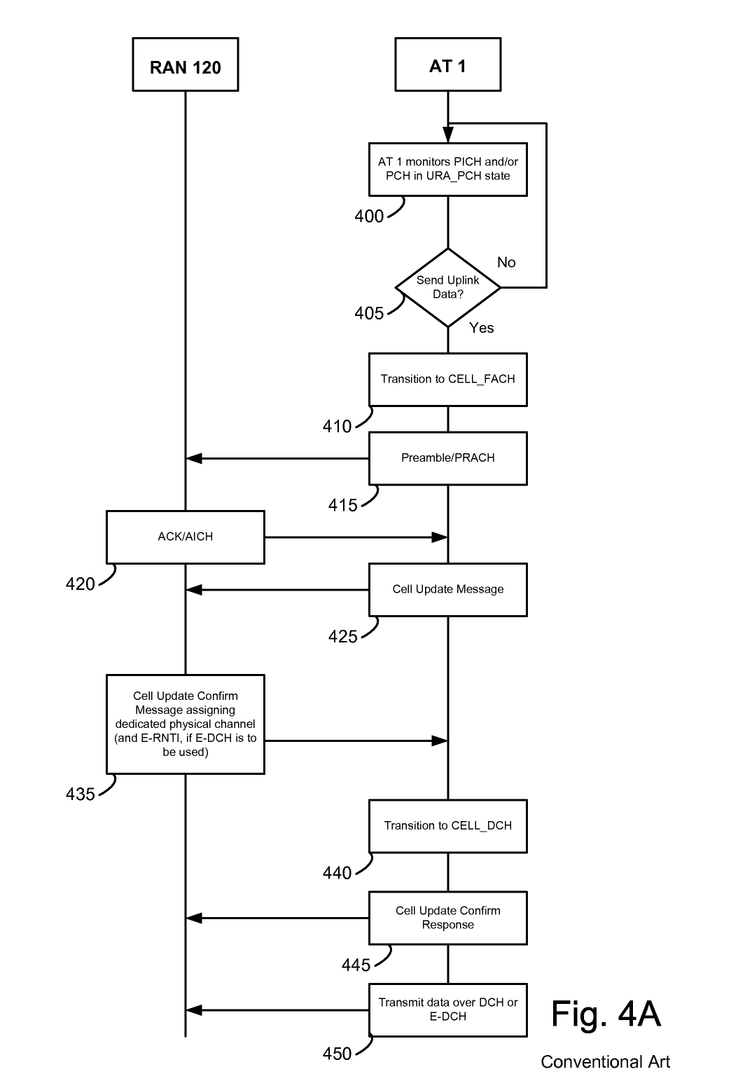

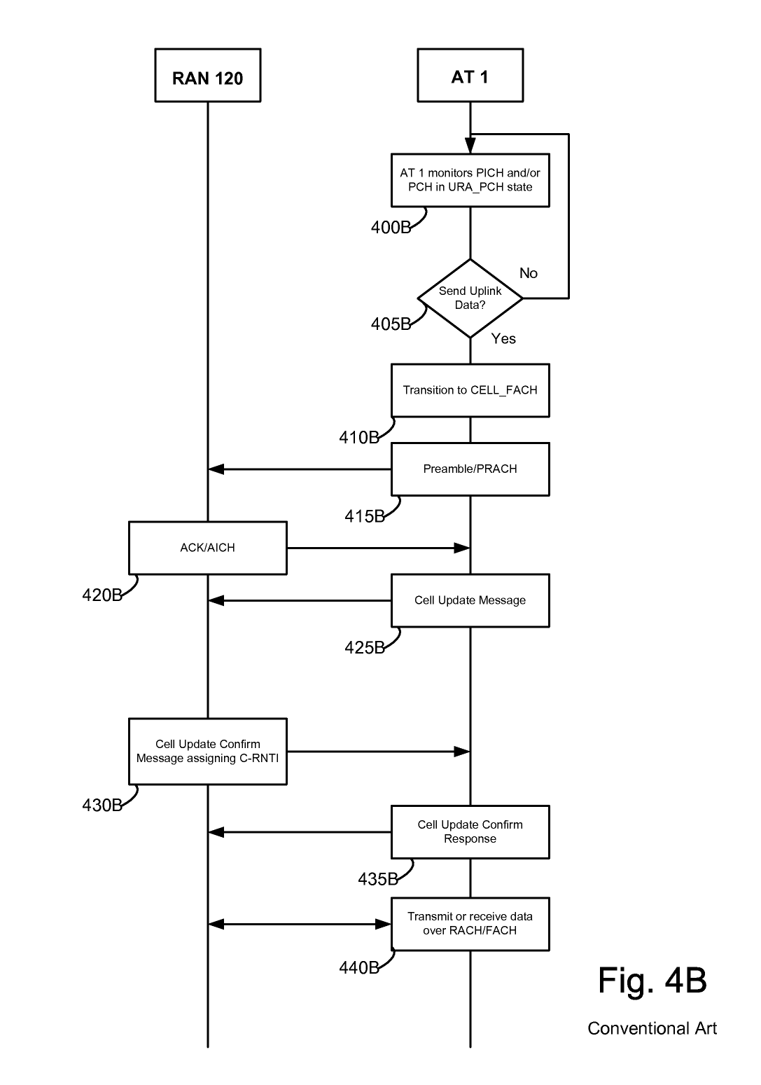

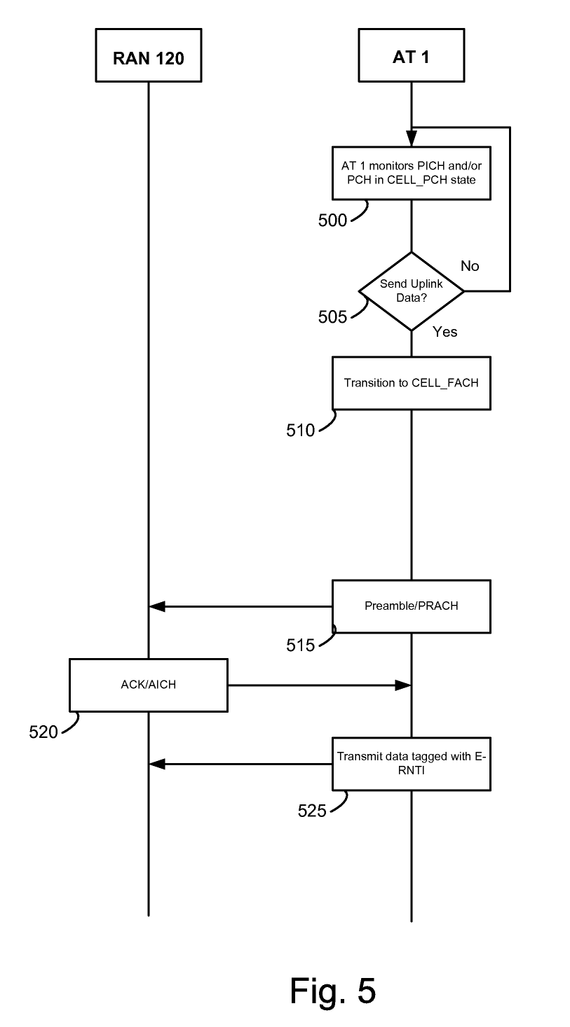

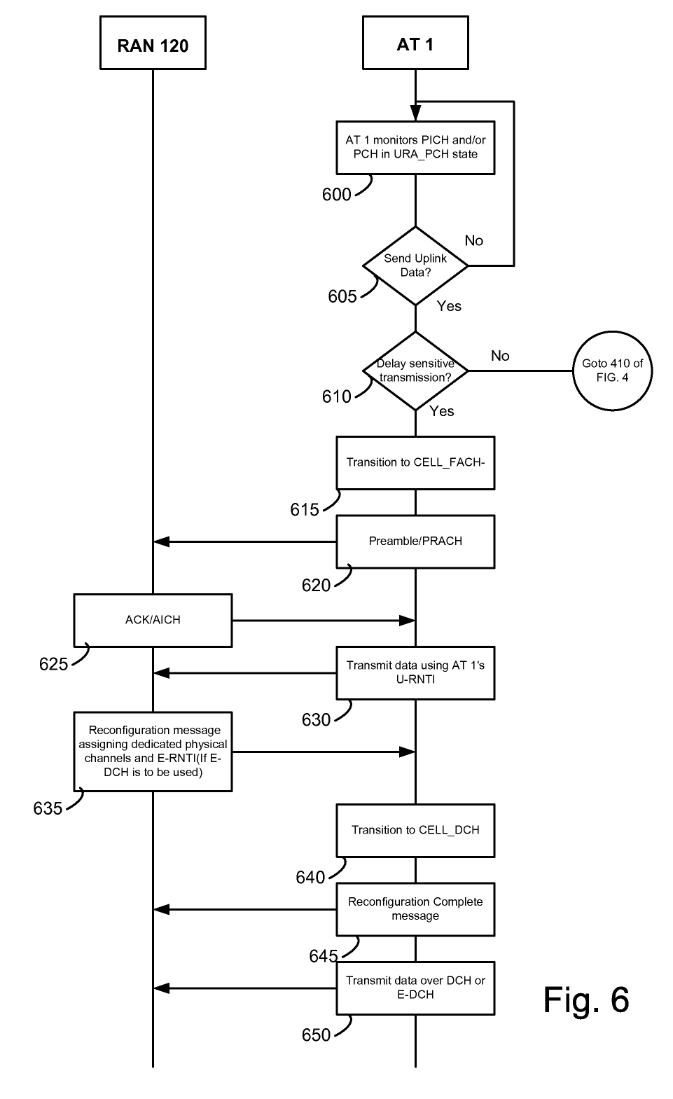

FIG. 4A illustrates a conventional process of setting up a reverse link data transmission over a dedicated channel (e.g., DCH or E-DCH). Referring to FIG. 4A, a given AT (“AT 1”) is in URA_PCH state, 400. Accordingly, AT 1 is dormant and periodically wakes up to check a downlink paging indication channel (PICH) and/or paging channel (PCH) to determine whether AT 1 is being paged, or whether AT 1 has entered a new URA. In 405, AT 1 determines whether to transition to CELL_FACH state in order to send uplink data. For example, if AT 1 determines, when waking up and checking the PICH and/or PCH, that AT 1 is not being paged and AT 1 does not need to send reverse link data for other reasons, then AT 1 need not transition to CELL_FACH state and the process returns to 400, and AT 1 continues to periodically wake up and check the PICH and/or PCH, and/or monitor for URA transitions. Otherwise, if AT 1 determines to send uplink data to the RAN 120 (e.g., because AT 1 is being paged, AT 1's URA has changed, or for some other reason), AT 1 transitions to CELL_FACH state, 410. When AT 1 first leaves CELL_PCH state or URA_PCH state and enters CELL_FACH state, AT 1 can send control messages over a reverse link common control channel (CCCH) using its U-RNTI, but AT 1 cannot send user data using a reverse link dedicated traffic channel (DTCH).

In CELL_FACH state, as illustrated in Table 1 (above), AT 1 gains access to the RACH (i.e., a reverse link shared channel) for uplink transmissions and monitors FACH (i.e., a forward link shared channel) for downlink transmissions from the RAN 120 (e.g., in release 7 or higher, AT 1 may also monitor the high-speed downlink shared channel (HS-DSCH), and in release 8 or higher, AT 1 may transmit on a reverse link common enhance dedicated channel (E-DCH)). Accordingly, in 415, AT 1 transmits a physical random access channel (PRACH) preamble (e.g., generated by using a scrambling code and a signature code) to a given Node B or base station within the RAN 120. The RACH is mapped to the PRACH, and the PRACH preamble is a short message (e.g., four bits of access information) used to request permission to access the RACH. As will be appreciated, the PRACH is a physical channel, and to send uplink data on the RACH, AT 1 first transmits preambles on the PRACH in 415 with successively increasing power (i.e., power ramping). If the preamble power reaches a level that the RAN 120 (e.g., the Node B or base station serving AT 1) can detect, the Node B or base station notifies AT 1 by sending an Acquisition Indicator (AI) over the AICH, which is also a physical channel. Therefore, the PRACH preamble in 415 is sent both to request permission to access the RACH, and also to figure out an acceptable power level for reverse link transmissions to the RAN 120 in AT 1's sector. Accordingly, in 420, the RAN 120 responds to the PRACH preamble by issuing an ACK/AICH message. Steps 415 and 420 generally correspond to a preamble power ramping, as is known in the art.

Next, AT 1 sends a cell update message on the RACH that includes AT 1's UTRAN Radio Network Temporary Identifier (RNTI) (U-RNTI), 425. The U-RNTI is discussed in more detail below, although it is noted that the U-RNTI is an identification assigned to an AT (e.g., during power-up, or upon transition to a new RNC serving area) that uniquely identifies an AT within a particular subnet, or set of sectors controlled by a single RNC.

In 435, the RAN 120 configures and transmits a Cell Update Confirm message that assigns dedicated physical channels for DPCH, and may also assign dedicated physical channels for the E-DCH with a E-DCH radio network temporary identifier (E-RNTI) if the E-DCH is to be used by AT 1 for reverse link data transmission. For example, in Release 8 of 3GPP, a E-RNTI may be used to distinguish between AT transmissions on the reverse link common E-DCH.

Next, AT 1 transitions to CELL_DCH state, 440, transmits a cell update confirm response message (e.g., a Radio Bearer Reconfiguration Complete message, a Transport Channel Reconfiguration Complete message and/or a Physical Channel Reconfiguration Complete message, based on whether the Radio Bearer, Transport Channel or Physical Channel is the higher layer to be-reconfigured in the Cell Update Confirm message of 425), 445 on a reverse link DCH or reverse link E-DCH, 445, and begins transmitting data on the reverse link to the RAN 120 on the DCH or E-DCH, 450.

FIG. 4B illustrates a conventional process of setting up data transmissions between the RAN 120 and a given AT (“AT 1”) over a shared channel (e.g., RACH or FACH). Referring to FIG. 4B, 400B through 425B generally correspond to 400 through 425, respectively, of FIG. 4A, and as such will not be described further for the sake of brevity.

Next, in 430B, the RAN 120 configures and sends a cell update confirm message that assigns a cell-RNTI (C-RNTI) to AT 1. C-RNTIs are generally smaller than U-RNTIs (e.g., 32 bits for U-RNTIs vs. 16 bits for C-RNTIs) because C-RNTIs are used to distinguish between ATs over a smaller area (e.g., within a cell for a C-RNTI, instead of a subnet for a U-RNTI). Thus, in FIG. 4, the U-RNTI is merely used in the cell update message to request the C-RNTI, which can then be used to send data between the RAN 120 and AT 1 on a shared channel (e.g., RACH or FACH) within a particular sector more efficiently.

It is appreciated that the C-RNTI is conventionally used for distinguishing between ATs on the RACH or FACH, which are shared transport channels. Transmissions over dedicated channels (DCHs), such as E-DCH, do not require UE or AT-specific identifiers (e.g., because it is assumed that only the AT to which the dedicated channel is assigned will use the dedicated channel), and instead use, for E-DCH, the E-RNTI, and so on. The 3GPP Standard prohibits uplink DTCH transmission over RACH without a valid C-RNTI, although the 3GPP Standard allows the transmission over FACH using a valid C-RNTI or U-RNTI. Thus, it will be appreciated that the only valid UE or AT ID in URA_PCH and/or CELL_PCH is the U-RNTI, because in either of these states a C-RNTI has not yet been assigned. Thus, conventionally, the DTCH/RACH cannot be accessed in the URA_PCH and/or CELL_PCH states in FIG. 4B because AT 1 requires a valid C-RNTI which cannot be assigned until these states are exited (e.g., with a transition to CELL_FACH, as in 410B).

After assigning the C-RNTI via the cell update confirm message in 430B, AT 1 transmits a cell update confirm response message (e.g., a Radio Bearer Reconfiguration Complete message, a Transport Channel Reconfiguration Complete message and/or a Physical Channel Reconfiguration Complete message, based on whether the Radio Bearer, Transport Channel or Physical Channel is the higher layer to be-reconfigured in the Cell Update Confirm message of 430B), 435B, on the RACH. At this point, it will be appreciated that AT 1 remains in CELL_FACH state, and does not transition to CELL_DCH state as in 440 of FIG. 4A because AT 1 can use the C-RNTI to transmit user data on a reverse link shared channel (i.e., the RACH), and not a reverse link dedicated channel (e.g., E-DCH, DCH, etc.).

Accordingly, in 440B, AT 1 can transmit data to the RAN 120 over the RACH and/or receive data from the RAN 120 over the FACH, with the data transmissions in either direction including the assigned and valid C-RNTI from 430B.

FIG. 5 illustrates a conventional process of setting up a reverse link data transmission performed in accordance with 3GPP Release 8. As noted above in Table 1, in 3GPP Release 8, an AT may transmit on the reverse link common E-DCH in CELL_FACH state. In 500 of FIG. 5, assume that AT 1 is in CELL_PCH state, and further assume that AT 1 has been assigned an E-RNTI previously in the current serving cell. Thus, unlike FIG. 4, AT 1 in FIG. 5 could start transmitting over the common E-DCH as soon as it receives the ACK on AICH, which allows data to be sent more quickly (i.e., with less set-up time), while in general also consuming more power at AT 1 and contributes more uplink interference to Node B, comparing to URA_PCH state, if it frequently moves across cell boundaries and needs to send cell update messages (since URA usually covers multiple Cells). In FIG. 5, if AT 1 were alternatively in URA_PCH state instead of CELL_PCH state, it will be appreciated that AT 1 would not have retained the E-RNTI, and a E-RNTI would need to be provisioned before AT 1 could access the E-DCH.

In 505, AT 1 determines whether to send data on the reverse link common E-DCH. If AT 1 determines not to send data on the reverse link common E-DCH, the process returns to 500. Otherwise, if AT 1 determines to send data on the reverse link common E-DCH to the RAN 120, AT 1 transitions to CELL_FACH state, 510, and transmits a PRACH preamble (e.g., generated by using a scrambling code and a signature code) to a given Node B or base station within the RAN 120, 515, and the RAN 120 responds to the PRACH preamble by issuing an ACK/AICH message, 520, as discussed above with respect to 415 and 420 of FIG. 4, respectively. Steps 515 and 520 generally correspond to a preamble power ramping, as is known in the art.

In 525, AT 1 transmits data to the RAN 120 on the reverse link common E-DCH including the previously assigned E-RNTI. While not shown in FIG. 5, the RAN 120 may send a message to resolve a collision between multiple ATs attempting to transmit at the same time in the event of a collision in AT 1's transmission at 525.

Referring again to FIG. 4B, as noted above, C-RNTIs have 16 bits, and are unique on a sector-basis or cell-basis, but are not ‘globally’ unique (e.g., unique across a subnet or region controlled by a given RNC). Thus, upon entry into a new cell, an AT is conventionally assigned a new C-RNTI to distinguish itself on the RACH or FACH in the new sector before beginning data transmission on the reverse link to the RAN 120, which delays the data transmission. Referring to FIG. 5, in cases where an E-RNTI (e.g., another cell-specific identifier) is assigned to an AT in CELL_PCH state, the AT is able to send data more quickly in FIG. 5 than in FIG. 4. However, the power demands of the CELL_PCH state also drain more power at the AT and causes more uplink interference to the Node B, as compared to the URA_PCH state (e.g., unless the URA correspond to a single cell).

Embodiments of the invention are directed to expediting the call set-up process by using a UTRAN RNTI (U-RNTI) at least during an initial uplink message from a given AT. As will be explained below in more detail, this permits the AT to be dormant in URA_PCH state which saves power and uplink interference as in FIG. 4, while also reducing a delay before data can be transmitted as in FIG. 5, which may result in a more efficient system in terms of both time/delay and power consumption.

As discussed above, a U-RNTI is a unique value in the UTRAN Registration Area (URA) and is typically not changed even in cases where the user equipment is moved to a different cell in the same RNC. However, when the serving RNC identifier is changed due to the change of the serving RNC, a new U-RNTI value may be allocated. More specifically, a U-RNTI allocated to an AT is valid so long as that AT remains within a region served by the same serving RNC, in contrast to C-RNTIs and E-RNTIs which have a validity range (i.e., a range in which the identifier is guaranteed to uniquely identify the AT without a collision) of a cell or sector. However, U-RNTIs are also larger than C-RNTIs and/or E-RNTIs. For example, a U-RNTI may include 32 bits, whereas C-RNTIs and/or E-RNTIs may include 16 bits. U-RNTIs are allocated to an AT by a serving RNC at the RAN 120 during establishment of a radio resource control (RRC) connection (e.g., or when the serving RNC ID is changed), and as mentioned enough, may remain the same at least so long as the AT remains with a region served by the serving RNC.

FIG. 6 illustrates a process of setting up a reverse link data transmission according to an embodiment of the present invention. In particular, FIG. 6 illustrates a modification to conventional FIG. 4A wherein an AT's U-RNTI is used at least within an initial uplink message carrying data to the RAN 120. Referring to FIG. 6, a given AT (“AT 1”) is in URA_PCH state, 600. Accordingly, AT 1 is dormant and periodically wakes up to check a downlink paging indication channel (PICH) (e.g., similar to a quick PCH in 1x, after which AT 1 will read a paging channel (PCH) to confirm the page and receive the paging message) and/or PCH to determine whether AT 1 is being paged. Also in 600, AT 1 determines whether AT 1 has entered a new URA by monitoring system information blocks over the downlink broadcast channel (BCH). In 605, AT 1 determines whether to transition to CELL_FACH state based on whether AT 1 has data to send on a reverse link or uplink to the RAN 120 (e.g., although in other embodiments, a paging of AT 1 is another trigger for entering CELL_FACH state). For example, if AT 1 determines that AT 1 does not have reverse link data to send and need not transition to CELL_FACH state, the process returns to 600 and AT 1 continues to periodically wake up and check the PICH and/or monitor for URA changes on the BCH. Otherwise, if AT 1 has data to send on the reverse link to the RAN 120 (e.g., in response to a page of AT 1 by the RAN 120, upon AT 1's own initiative, to request a new U-RNTI if AT 1 determines its URA has changed, etc.), the process advances to 610.

In 610, instead of proceeding directly to CELL_FACH state, AT 1 determines whether its intended data transmission to the RAN 120 is delay sensitive. As used herein, a ‘delay sensitive’ data transmission is any data transmission AT 1 determines to be of sufficient importance to warrant using a U-RNTI at least in an initial data transmission, which permits data to be sent more quickly because AT 1 does not yet have a C-RNTI, as will be described below in more detail. For example, an important metric in push-to-talk (PTT) is how fast the PTT call can be set up, which is based on an initial PTT latency. Thus, if AT 1 is an initiator of a PTT call, its request to initiate a PTT session can be determined to be delay sensitive, in an example. In an alternative example, a message can be assumed to be delay sensitive if AT 1 does not yet have an assigned C-RNTI or E-RNTI. In another alternative example, AT 1 may check the L2 (MAC layer) parameters/identifiers of a downlink message (e.g., an ANNOUNCE message for a PTT call) to determine delay sensitivity for a message to be sent in response to the downlink message. For example, if the MAC header of the downlink message contains a C/T field (e.g., a Logical Channel Identifier) is mapped to an earlier established Radio Bearer with QoS profile of low latency service, the RAN 120 can be configured to treat the packet as delay sensitive. If AT 1 determines its transmission is not delay sensitive, the process advances to 410 of FIG. 4, and conventional call set-up methodologies are used to set up AT 1's call. Otherwise, the process advances to 615, and AT 1 enters a state denoted as “CELL_FACH-”. As will be appreciated by one of ordinary skill in the art, while CELL_FACH- state is described below as a separate state than the conventional CELL_FACH state, it will be appreciated that another interpretation of this state could describe CELL_FACH- as an enhanced or modified version of the more traditional CELL_FACH state. In other words, CELL_FACH- state need not be implemented in conjunction with a separately implemented CELL_FACH state, but could rather be implemented as an enhanced version of CELL_FACH state.

State CELL_FACH- is similar to state CELL_FACH, except state CELL_FACH- is configured to tag at least initial uplink data transmissions to the RAN 120 with its U-RNTI (e.g., established during power-up for a given subnet or RNC serving area) instead of a C-RNTI or E-RNTI. An updated table showing dedicated traffic channel (DTCH) to transport channel mappings in radio resource control (RRC) connected mode, is in Table 2 as follows:

TABLE 2
DTCH to Transport Channel mappings in RRC connected mode

| | RACH | FACH | DCH | E-DCH | HS-DSCH |
|---|---|---|---|---|---|
| CELL_DCH | Yes | Yes | Yes | Yes | Yes |
| CELL_FACH | Yes (C-RNTI) | Yes | No | Yes (rel. 8) | Yes (rel. 7) |
| CELL_FACH⁻ | Yes (U-RNTI) | Yes | No | No | No |
| CELL_PCH | No | No | No | No | Yes (rel. 7) |
| URA_PCH | No | No | No | No | No |

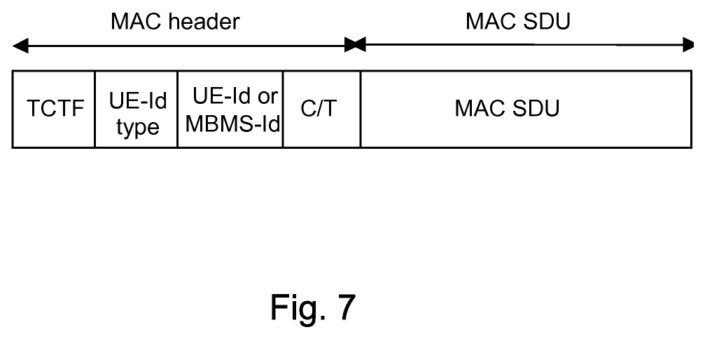

Accordingly, AT 1 transmits a PRACH preamble, 620, and the RAN 120 responds to the PRACH preamble by issuing an ACK/AICH message, 625, which corresponds to preamble power ramping, as is known in the art. Next, AT 1 transmits data on the reverse link RACH that includes AT 1's U-RNTI, 630. For example, as discussed below with respect to FIG. 7, the U-RNTI may be contained in a UE-ID field or portion of a MAC header of the reverse link RACH data packet. In other words, AT 1 need not transmit a cell update message (e.g., to establish a dedicated physical channel for DCH and, if being configured, to establish dedicated physical channels for E-DCH with E-RNTI) before transmitting data, but can rather send data sooner by including the U-RNTI. As will be appreciated, the transmission of the U-RNTI in place of the C-RNTI represents a tradeoff between transmission latency and bandwidth consumption. In other words, the U-RNTI based message of 630 of FIG. 6 consumes more bandwidth on the RACH than the C-RNTI based message of 425 (e.g., 16 bits more, if U-RNTI=32 bits while C-RNTI=16 bits), while the U-RNTI based message permits AT 1 to transmit data sooner than waiting for an establishment of a dedicated physical channel for DCH and, if being configured, to establish dedicated physical channels for E-DCH with E-RNTI. This is why, in an example, U-RNTI based data messages can be restricted to delay-sensitive messages to reduce interference on the RACH, although it is still at least theoretically possible for the U-RNTI to be used for all packets.

Upon receiving the U-RNTI based data message on the reverse link RACH, the RAN 120 sends the Reconfiguration message (Radio Bearer/Transport Channel/Physical Channel Reconfiguration message) on the FACH to establish a dedicated physical channel for AT 1 for use in AT 1's current sector on subsequent reverse link transmissions. 635. Thus, the RAN 120 treats AT 1's U-RNTI based data transmission as a request for establish a dedicated channel, similar to the RAN 120's response to a cell update message, as in FIG. 4. Upon receiving the cell update confirm message from the RAN 120, AT 1 transitions to the CELL_DCH state, 640, and transmits a Reconfiguration Complete message (e.g., a Radio Bearer Reconfiguration Complete message, a Transport Channel Reconfiguration Complete message and/or a Physical Channel Reconfiguration Complete message, based on whether the Radio Bearer, Transport Channel or Physical Channel is the higher layer to be-reconfigured), 645 on the reverse link DCH or common E-DCH to acknowledge the cell update confirm message, 645. Alternatively, in 645, AT 1 transmits a UTRAN Mobility Info Confirm message on the reverse link RACH to acknowledge the cell update confirm message. In 650, AT 1 continues to transmit data to the RAN 120 on the reverse link DCH or common E-DCH, as assigned in 635 via the Reconfiguration message. Thus, in FIG. 6, the data transmission of 630 can be considered a first or initial data packet in a sequence of data packets, and the transmissions of 645 and 650 can be considered as one or more subsequent or additional packets in the sequence of data packets.

While FIG. 6 has been described-above with respect to using a U-RNTI for an initial packet in a sequence of packets, it will be appreciated that similar methodologies may be applied within the E-RNTI framework described above with respect to FIG. 5, such that the U-RNTI implementation is not necessarily limited to data transmissions over RACH. Further, it is at least possible that all data transmissions include the U-RNTI. Thus, in an example, if the RAN 120 is delayed for some reason in assigning the dedicated physical channel for DCH or E-DCH in 635, after an initial data packet including an AT's U-RNTI, the AT can continue to send data tagged with its U-RNTI at least until the DCH or E-DCH is assigned.

Further, in FIG. 6, subsequent to the initial data packet transmission that includes AT 1's U-RNTI, the RAN 120 sends a Reconfiguration message that allocates a DCH and/or E-DCH to AT 1 on which AT 1 can send one or more additional data packets, as in FIG. 4A. However, in other embodiments, the RAN 120 can alternatively assign a C-RNTI to AT 1 for transmitting on the RACH, as in FIG. 4B. It will be appreciated that the RAN 120 can determine whether to permit AT 1 to transmit on a dedicated channel (e.g., DCH or E-DCH), or a shared channel (e.g., the RACH), and can assign the necessary resources based upon this determination. Thus, while not explicitly shown in FIG. 6, the Reconfiguration message of 635 can alternatively assign to AT 1 a C-RNTI, which AT 1 can then use to transmit on the RACH in 650 (e.g., instead of the DCH or E-DCH).

FIG. 7 illustrates a media access control (MAC) packet according to an embodiment of the present invention. Referring to FIG. 7, the MAC packet includes a MAC header portion and a MAC service data unit (SDU) portion. The MAC header portion includes a Target Channel Type Field (TCTF) portion, a UE type portion, a UE ID or Multimedia Broadcast Multicast Service (MBMS) ID portion, and a C/T portion. In FIG. 7, the MAC header portion is for DTCH and DCCH which are not mapped on HS-DSCH or E-DCH. Thus, the MAC header illustrated in FIG. 7 is not necessarily applicable to E-DCH, because the E-DCH is different than DCH, RACH or FACH. However, it will be appreciated that a similar type of header manipulation (i.e., modifying the header so as to include the U-RNTI) may be applicable to E-DCH in MAC-i, which is introduced in Release 8.

The TCTF field is a double-bit flag that provides identification of the logical channel class on FACH, and RACH transport channels (i.e. whether the SDU portion carries CCCH or CTCH or dedicated channel information of shared channel control information).

The C/T field provides identification of the logical channel instance when multiple logical channels are carried on the same transport channel. The C/T field is used also to provide identification of the logical channel type on dedicated transport channels and on FACH and RACH when used for user data transmission. The size of the C/T field may be variable (e.g., 4 bits).

The UE-ID field provides an identifier of the UE. Conventionally, the UE ID corresponds to a sector or cell-specific RNTI, such as an E-RNTI or C-RNTI (e.g., 16 bits). In an embodiment of the invention, however, the UE-ID field may include the U-RNTI (e.g., 32 bits), and the UE-ID type may be set to a given bit setting (e.g., “00”) to indicate that the UE-ID field corresponds to a U-RNTI. Accordingly, in an example, the MAC header portion may be configured as follows in at least one embodiment of the present invention:
Target Channel Type Field (TCTF)=01 (DTCH or DCCH)
UE-ID type=00 (U-RNTI)
UD-ID=U-RNTI (32 bits)
C/T=logical channel number (4 bits)

As will be appreciated by one of ordinary skill in the art, if data is sent on the reverse link over a shared channel such as the RACH or E-DCH, the UTRAN or RAN 120 will assign some type of identifier, such as the C-RNTI or E-RNTI, respectively, by which a transmitting AT can identify itself. In embodiments of the invention, if the transmitting AT does not yet have a sector-specific identifier for itself, the transmitting AT has the option of configuring the RACH or E-DCH message to identify the transmitting AT based on a more unique identifier, such as its U-RNTI. By configuring a reverse link packet on a shared channel to include a more unique identifier (e.g., a globally unique identifier, or at least a RNC-wide unique identifier, such as a U-RNTI) than a cell or sector-wide unique identifier, an AT can transmit a reverse link data packet, without first acquiring a cell-specific AT identifier, with less risk of a collision of identifiers (e.g., U-RNTIs) with another AT in that sector. Accordingly, while the identifier that is unique over a greater region than the other identifier may include more bits, an AT can potentially begin transmitting data (e.g., related to PTT call set-up) more quickly, which can improve performance metrics associated with delay sensitive applications.

Further, while above-described embodiments of the present invention disclose sending a first uplink data packet with a U-RNTI as an implicit request for allocation of a dedicated physical channel and/or a cell-specific AT ID, such as a E-RNTI or C-RNTI, and sending subsequent uplink packets over DCH, E-DCH (with the allocated E-RNTI) or RACH (with the allocated C-RNTI), it will be appreciated that one or more additional packets may include the U-RNTI. It is even possible that an AT can communicate with the RAN 120 without acquiring a dedicated physical channel or E-RNTI or C-RNTI at any point, and can simply use the U-RNTI in reverse link communications to identify itself, although it is understood that performance can degrade if the U-RNTI is overused in this manner as the U-RNTI has a higher number of bits (e.g., 32 bits) than the E-RNTI or C-RNTI (e.g., 16 bits).

Further, it is understood that CELL_PCH state is similar to URA_PCH state in some respects (e.g., see Tables 1 and 2, above). Thus, where reference is made to URA_PCH in the above-description and figures, it will be appreciated that similar methodologies can be applied to CELL_PCH state (e.g., AT 1 may begin in CELL_PCH state instead of URA_PCH state in 600 of FIG. 6, in an example).

Further, it will be appreciated that embodiments of the invention whereby the U-RNTI is used in transmissions over the RACH can be applied to any 3GPP or Frequency Division Duplex (FDD) wireless communication protocol (e.g., any one of 3GPP Release R99 through Release 8), whereas the U-RNTI can be used over the common E-DCH in 3GPP Release 8 (or higher).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., access terminal). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of transmitting data within a wireless communications system operating in accordance with a given wireless communications protocol, comprising:
configuring, at a given access terminal, at least an initial data packet in a sequence of data packets to include a data portion including a given amount of data and a header portion including an identifier of a first type, the identifier of the first type configured to uniquely identify the given access terminal in more than one of a subset of sectors of the wireless communications system; and
transmitting the initial data packet over a reverse link of a shared channel to an access network.

2. The method of claim 1, wherein the identifier of the first type is a Universal Mobile Telecommunications Service (UMTS) Terrestrial Radio Access Network (UTRAN) Radio Network Temporary Identifier (RNTI) (U-RNTI) that uniquely identifies the given access terminal within a serving region of a given radio access controller (RNC).

3. The method of claim 1, wherein the configuring and transmitting steps occur in a first state of the given access terminal.

4. The method of claim 3, wherein the reverse link of the shared channel corresponds to a reverse link random access channel (RACH).

5. The method of claim 3, further comprising:
receiving, in response to the transmission of the initial data packet, (i) a cell update confirm message that assigns, to the given access terminal, an identifier of a second type used to uniquely identify the given access terminal within the given access terminal's current sector of the wireless communications system for transmissions on the reverse link of the shared channel, (ii) or a reconfiguration message that assigns a dedicated channel to the given access terminal.

6. The method of claim 5, further comprising:
transitioning, after the receiving step, from the first state to a second state.

7. The method of claim 6, wherein, in the second state, if the given access terminal receives the cell update confirm message that assigns the identifier of the second type, the given access terminal sends one or more additional packets in the sequence of data packets having a header portion including the identifier of the second type.

8. The method of claim 7, wherein the first state is URA_PCH or CELL_PCH, and the second state is CELL_FACH state.

9. The method of claim 6, wherein, in the second state, if the given access terminal receives the reconfiguration message that assigns the dedicated channel, the given access terminal sends one or more additional packets in the sequence of data packets on the assigned dedicated channel.

10. The method of claim 9, wherein the second state is a CELL_DCH state, the first state is URA_PCH or CELL_PCH, and the dedicated channel corresponds to a common enhanced dedicated channel (E-DCH) or dedicated channel (DCH).

11. The method of claim 9, wherein the one or more additional packets include a reconfiguration complete message.

12. The method of claim 11, wherein the reconfiguration complete message is a Transport Channel Reconfiguration Complete message, a Radio Bearer Reconfiguration Complete message, and/or a Physical Channel Reconfiguration Complete message.

13. The method of claim 5, wherein the identifier of the second type corresponds to a Cell Radio Network Temporary Identifier (RNTI) (C-RNTI) that uniquely identifies the given access terminal within a region of a given radio access controller (RNC).

14. The method of claim 1, wherein the given wireless communications protocol does not specify an inclusion of identifiers of the first type within the header portions of data packets.

15. The method of claim 14,
wherein the shared channel corresponds to a reverse link access channel (RACH) and the given wireless communications protocol is one of 3GPP Release 99 through Release 8,
or wherein the shared channel corresponds to an enhanced dedicated channel (E-DCH) and the given wireless communications protocol is 3GPP Release 8 or higher.

16. The method of claim 1, wherein the subset of sectors corresponds to a subnet.

17. The method of claim 1,
wherein the configuring step is only performed if the initial data packet carries delay-sensitive data, and
wherein, if the initial data packet does not carry delay-sensitive data, the initial data packet is sent after either (i) a dedicated channel is assigned to the given access terminal, or (ii) after an identifier of a second type configured to uniquely identify the given access terminal in a single sector is assigned to the given access terminal.

18. A method of receiving data within a wireless communications system operating in accordance with a given wireless communications protocol, comprising:
receiving, at an access network, at least an initial data packet in a sequence of data packets including a data portion having a given amount of data and a header portion including an identifier of a first type, the identifier of the first type configured to uniquely identify a given access terminal in more than one of a subnet of sectors of the wireless communications system;
determining whether subsequent data packets in the sequence of data packets are to be received from the given access terminal on a shared channel or a dedicated channel;
configuring, based on the determining step, a message to (i) assign the dedicated channel to the given access terminal, or to (ii) assign an identifier of a second type to uniquely identify the given access terminal in a single sector of the wireless communications system;
sending the configured message to the given access terminal; and
receiving one or more additional packets in the sequence of data packets from the given access terminal in accordance with the assignment of the configured message.

19. The method of claim 18, wherein the identifier of the first type is a Universal Mobile Telecommunications Service (UMTS) Terrestrial Radio Access Network (UTRAN) Radio Network Temporary Identifier (RNTI) (U-RNTI) that uniquely identifies the given access terminal within a serving region of a given radio access controller (RNC).

20. The method of claim 18, wherein the initial data packet is received on a reverse link random access channel (RACH).

21. The method of claim 18,
wherein the configured message is configured to assign the dedicated channel, and
wherein the one or more additional packets in the sequence of data packets are received on the dedicated channel.

22. The method of claim 21, wherein, the configured message corresponds to a reconfiguration message.

23. The method of claim 22, wherein the reconfiguration message is a transport channel reconfiguration complete message, a Radio Bearer Reconfiguration Complete message, and/or a Physical Channel Reconfiguration Complete message.

24. The method of claim 21, wherein the one or more additional packets include a reconfiguration complete message.

25. The method of claim 18,
wherein the configured message is configured to assign the identifier of the second type, and
wherein the one or more additional packets in the sequence of data packets have a header portion including the identifier of the second type.

26. The method of claim 25, wherein the configured message corresponds to a cell update confirm message

27. The method of claim 18, wherein the identifier of the second type corresponds to a Cell-Radio Network Temporary Identifier (RNTI) (C-RNTI)

28. The method of claim 18, wherein the given wireless communications protocol does not specify an inclusion of identifiers of the first type within the header portions of data packets.

29. The method of claim 28, wherein the given wireless communications protocol is Release 99 through Release 8.

30. The method of claim 18, wherein the subset of sectors corresponds to a subnet.

31. An access terminal configured to transmit data within a wireless communications system operating in accordance with a given wireless communications protocol, comprising:
means for configuring at least an initial data packet in a sequence of data packets to include a data portion including a given amount of data and a header portion including an identifier of a first type, the identifier of the first type configured to uniquely identify the access terminal in more than one of a subset of sectors of the wireless communications system; and
means for transmitting the initial data packet over a reverse link of a shared channel to an access network.

32. An access network configured to receive data within a wireless communications system operating in accordance with a given wireless communications protocol, comprising:
means for receiving at least an initial data packet in a sequence of data packets including a data portion having a given amount of data and a header portion including an identifier of a first type, the identifier of the first type configured to uniquely identify a given access terminal in more than one of a subnet of sectors of the wireless communications system;
means for determining whether subsequent data packets in the sequence of data packets are to be received from the given access terminal on a shared channel or a dedicated channel;
means for configuring, based on the determination, a message to (i) assign the dedicated channel to the given access terminal, or to (ii) assign an identifier of a second type to uniquely identify the given access terminal in a single sector of the wireless communications system;
means for sending the configured message to the given access terminal; and
means for receiving one or more additional packets in the sequence of data packets from the given access terminal in accordance with the assignment of the configured message.

33. An access terminal configured to transmit data within a wireless communications system operating in accordance with a given wireless communications protocol, comprising:
logic configured to configure at least an initial data packet in a sequence of data packets to include a data portion including a given amount of data and a header portion including an identifier of a first type, the identifier of the first type configured to uniquely identify the access terminal in more than one of a subset of sectors of the wireless communications system; and
logic configured to transmit the initial data packet over a reverse link of a shared channel to an access network.

34. An access network configured to receive data within a wireless communications system operating in accordance with a given wireless communications protocol, comprising:
logic configured to receive at least an initial data packet in a sequence of data packets including a data portion having a given amount of data and a header portion including an identifier of a first type, the identifier of the first type configured to uniquely identify a given access terminal in more than one of a subnet of sectors of the wireless communications system;
logic configured to determine whether subsequent data packets in the sequence of data packets are to be received from the given access terminal on a shared channel or a dedicated channel;
logic configured to configure, based on the determination, a message to (i) assign the dedicated channel to the given access terminal, or to (ii) assign an identifier of a second type to uniquely identify the given access terminal in a single sector of the wireless communications system;
logic configured to send the configured message to the given access terminal; and
logic configured to receive one or more additional packets in the sequence of data packets from the given access terminal in accordance with the assignment of the configured message.

35. A non-transitory computer-readable storage medium including instructions stored thereon, which, when executed by an access terminal configured to transmit data within a wireless communications system operating in accordance with a given wireless communications protocol, cause the access terminal to perform operations, the instructions comprising:
program code to configure at least an initial data packet in a sequence of data packets to include a data portion including a given amount of data and a header portion including an identifier of a first type, the identifier of the first type configured to uniquely identify the access terminal in more than one of a subset of sectors of the wireless communications system; and
program code to transmit the initial data packet over a reverse link of a shared channel to an access network.

36. A non-transitory computer-readable storage medium including instructions stored thereon, which, when executed by an access network configured to receive data within a wireless communications system operating in accordance with a given wireless communications protocol, cause the access network to perform operations, the instructions comprising:
program code to receive at least an initial data packet in a sequence of data packets including a data portion having a given amount of data and a header portion including an identifier of a first type, the identifier of the first type configured to uniquely identify a given access terminal in more than one of a subnet of sectors of the wireless communications system;
program code to determine whether subsequent data packets in the sequence of data packets are to be received from the given access terminal on a shared channel or a dedicated channel;
program code to configure, based on the determination, a message to (i) assign the dedicated channel to the given access terminal, or to (ii) assign an identifier of a second type to uniquely identify the given access terminal in a single sector of the wireless communications system;
program code to send the configured message to the given access terminal; and
program code to receive one or more additional packets in the sequence of data packets from the given access terminal in accordance with the assignment of the configured message.
